(19) United States
(12) Patent Application Publication
(10) Pub. No.: US 2026/0283126 A1
(43) Pub. Date: Sep. 24, 2026

(54) Trotline-Crabbing Bag and Mechanism for Baiting Trotline-Crabbing Bags on a Trotline

(71) Applicant: Joel Denny, Centerville, MD (US)

(72) Inventor: Joel Denny, Centerville, MD (US)

(21) Appl. No.: 19/660,597

(22) Filed: Apr. 28, 2026

Related U.S. Application Data
(63) Continuation-in-part of application No. 18/227,869, filed on Jul. 28, 2023, now abandoned.
Application No. 18/227,869 is a continuation-in-part of application No. 17/519,467, filed on Nov. 4, 2021, now abandoned.
(60) Provisional application No. 63/230,579, filed on Aug. 6, 2021.

(51) Int. Cl. A01K 73/02; A01K 91/18

(52) U.S. Cl. CPC A01K 73/02; A01K 91/18

(57) ABSTRACT

A trotline crabbing bag having an elongated body and opposite end portions is disclosed. A sidewall of the body has a primary opening and defines an interior region for retaining crab bait (e.g., about 3 to about 6 clams) therein, and a plurality of secondary openings ranging in size from about 1 mm to about 10 mm for enabling crab bait essence to pass therethrough to lure one or more target crabs to the bait. The body includes a slidably openable and closeable slide fastener overlaying the primary opening and secured to the sidewall between the opposite end portions. The slide fastener, when open, allows bait to be inserted into the interior region and, when closed, retains bait within the interior region.

### REFERENCE TO RELATED APPLICATIONS

The current Nonprovisional Patent Application is a Continuation-In-Part (“CIP”) of U.S. application Ser. No. 18/227,869 (filed Jul. 28, 2023) which, in turn, is a CIP of Nonprovisional application Ser. No. 17/519,467 (filed Nov. 4, 2021) which, in turn, is based upon U.S. Provisional Patent Application Ser. No. 63/230,579 (filed Aug. 6, 2021), all hereby incorporated by reference in their entireties pursuant to 35 USC § 120.

The present subject matter is directed, in general, to the field of trotline crabbing, and is directed, more particularly, to a trotline-crabbing mechanism which I developed to reduce an extensive amount of time normally required by trotline crabbers to bait bags on their trotlines. The present subject matter also discloses my trotline-crabbing bag design.

### BACKGROUND

In a crab fishery, it was common (about a hundred years ago) to use long lines, sometimes a mile or more in length, with ends attached to buoys moored in position by anchorages. At intervals along such a line were much shorter lines carrying the bait. The shorter lines would rest on the bottom of the crab fishery and crabbers would periodically start at one buoy and haul a boat along by the line to the other buoy, using a dip net along the way. This method was difficult to carry into proper effect by a single person since it was (and still is) very difficult, for a single person to pull on the line and properly use the dip net simultaneously, resulting in many crabs escaping capture. U.S. Pat. No. 1,777,783 to Burns et al. is directed to an automatic crab-catching device, believed to solve this problem.

U.S. Pat. No. 2,599,113 to Latta et al. discloses a trotline setter mechanism adapted and configured for attachment to a boat gunwale and designed for use in trotline fishing. U.S. Pat. No. 3,419,990 to Lewis et al. is directed to a fishing apparatus having a pair of intermeshing gears mounted on a base for drawing a trotline out of water for re-baiting and removing fish caught on hooks of the “trots” (or droplines) of a mainline of the trotline.

U.S. Pat. No. 3,775,894 to Goddard discloses an apparatus for attaching hooks to a trotline and for setting a trotline. U.S. Pat. No. 4,685,243 to Pugh discloses a trotline reel and hook holder that prevents entanglement of hooks and stores hooks in an orderly fashion.

A trotline, simply stated, is a system consisting of a line of heavier-grade cord which can be manufactured from preselected woven fibers which, in past times, have typically been cotton fibers but at the present time are often synthetic or polymeric fibers. There are many, like myself, who use trotlines to catch crabs. “Trotline crabbers,” as we are called, often attach 400-700 bags, each containing 3-6 clams, at spaced intervals along a trotline.

While there is no mention of a trotline in the following prior art, U.S. Pat. No. 5,497,582 to Kuhn discloses a crabbing bait holder frame including a pair of joined planar members adapted to hold bait in position therebetween. The planar members include openings and locking tab lengths along its top, bottom, and side edges of a frame to secure the planar members together. The frame is raised or lowered into water by a dropline to support the weight of one or more crabs holding onto the frame while eating bait inside. US published application 2006/0042146 to Waddy, Jr. et al. discloses a fishing lure including a bag formed of open mesh material closed at one end, open at its opposite end, and having a drawstring for closing the open end, to retain a portion of a fishhook placed within the bag and a leader attached to the fishhook and extending through the open end.

U.S. Pat. No. 6,848,210 to Altman et al. is directed to a biodegradable container for holding and distributing chum. The container, biodegradable for avoiding environmental and aesthetic pollution, includes a plurality of perforations through its sidewalls to attract fish. U.S. Pat. No. 7,490,432 to Gillihan discloses a bait bag-and-hook combination that includes a bag mounted on a hook in such a way that the bag does not prevent impaling game fish. The bag includes an easy-opening and re-closing apparatus which efficiently re-fills a bag. Moreover, bags are said to be manufactured of material durable enough to withstand the underwater environment yet permeable enough to release the scent of bait contained within. US published application 2018/0242566 to Hutchinson is directed to containers for dispensing bait in variable amounts and at variable rates. Configurations of two attachable sleeves are changed, with different configurations resulting in different overlapping of openings in attachable sleeves. Diverse opening overlap allows fishermen a flexibility to better control dispensing of bait and/or chum by varying size of an opening.

US published application 2019/0029243 to Troshinsky discloses a chum delivery device having a body including a plurality of openings through its sidewall, at least one open end, at least one removable cap, and one or more hook attachments. The plural openings through the sidewall of the body are configured to allow chum within the body to be released and the removable caps are configured to seal the open ends of the body. US published application 2021/0274765 to Troshinsky discloses what US 2019/0029243 does but further discloses a chum delivery system that includes a plurality of depressions configured for insertion of chum and a chum delivery device that has a plurality of holes.

For principles of trotline crabbing, see U.S. Pat. No. 5,157,858 to Lockner et al., PRIOR ART, hereby incorporated by reference in its entirety. A crab line roller mechanism 10, attached to and outwardly extending from an upper surface 16 of a boat 12, is used to raise and guide a trotline 18 in a body of water 14. The trotline 18 (FIG. 1), depicting trotline crabbing as practiced by a trotline crabber 17 of at least a generation ago, shows bait 20 attached to trotline 18. At that time, the bait 20 would have been decaying chicken or eel. (Current trotline crabbers use clams, held within bags secured to their trotlines, as bait.) The bait 20 lures a submerged crab 15 which begins to feed. The trotline 18 is next raised to the surface of water 14, enabling the crabber 17 to catch the crab 15 with a net 19. While current trotline crabbers often work from a larger boat and use equipment more sophisticated than what is shown in FIG. 1, their crab-catching efficiency is restricted by the time needed to bait their trotlines, a “problem” that the present subject matter solves.

For the present subject matter, the term “trotline-crabbing bag” shall be used to describe a ventilated and elongated bag, sack, pouch, or other crab-bait containing article of manufacture of predetermined shape and size having at least one substantial opening adapted, dimensioned, and configured to introduce crab bait into the trotline-crabbing bag. The opening is closeable, using a slide fastener such as a zipper, to securely retain the crab bait within the trotline-crabbing bag. Such trotline-crabbing bags can be manufactured from natural materials (e.g., cotton), synthetic material (e.g., nylon, polyester, polyaramid). Sides of the bags include much smaller openings to attract crabs to bait contained within.

Many current trotline crabbers may use a trotline of about 3,000-4,000 feet in length (with 3,600-foot lengths being common). As a result, trotline crabbers frequently may have about 400 to about 700 bags (or about 500 to about 600 bags) removably attached to their trotlines, at select spaced-apart intervals. Current trotline crabbers may use mesh bags of such materials as polypropylene, polyurethane, rayon, polyaramid, polyethylene, or nylon, open at one end with apertured sidewalls. Crabbing trotlines are re-baited as follows. When a length of trotline with an attached plurality of crab-baited bags is deemed to contain “spent” bait requiring re-baiting bags, it takes a professional crabber about 3-5 hours or more to manually re-bait all bags on a single trotline. Reducing the amount of time required by a trotline crabber to do so, would free-up a crabber to use a trotline to catch crabs, for sale. Throughout this patent specification, the term “spent” crab bait shall be understood to refer to bait, pulled through so much water while fixed to a trotline to enable a trotline crabber to catch crabs drawn to the bait, that the bait no longer serves as a crab attractant.

The present subject matter solves problems inherent in design of polymeric mesh bags currently favored by trotline crabbers. Such mesh bags, essentially elongated sleeves of polymeric mesh material, are closed at one end portion and open at the opposite end portion. Current “bag refresh” trotline-crabbing practice requires a trotline crabber to first dispose of spent bait from each bag (secured to the trotline so long that its contained bait is no longer effective for luring crabs to the bag) and thereafter re-load each now empty bag with fresh bait. Since each spent bait bag is manually removed from a trotline, and thereafter manually re-attached (after fresh bait is substituted for spent bait), a significant amount of time is spent by trotline crabbers removing bags from a trotline and re-attaching each bag now filled with “fresh” bait to the trotline. The present subject matter solves these and other problems associated with the removal and re-attachment of bait bags to trotlines.

### SUMMARY

Briefly summarizing this aspect of the present subject matter, the bag, secured to a trotline and sized and configured to contain crab bait, includes an elongated body and a slide fastener. The bag body includes opposite end portions and a sidewall. The body includes an interior region dimensioned to contain crab bait (3-6 clams) within the body.

The bag sidewall includes a primary opening oriented between the opposed bag end portions. In embodiments, the sidewall includes plural secondary openings of a size and configuration that spans merely releasing the scent of crab bait contained within to permitting a portion of the crab bait within the interior region to extend through at least one of the secondary openings to attract at least one crab to the sidewall to feed on bait contained within. In other embodiments, secondary openings are as described in the detailed description. When a bag is fixed (i.e., at one end portion) to a trotline, the slide fastener, secured to the sidewall, is openable and/or closeable over the primary opening.

Refilling a bag of my present design thus does not require removal from a trotline.

While a zipper is well known and a preferred slide fastener, the present subject matter extends to the broader term “slide fastener,” a mechanism comprising two parallel tracks of teeth or coils that are inter-lockable or separable by pulling a slide between them.

Additional aspects and features of the present subject matter-solving various problems not solved by the prior art reviewed above-shall become clear to a person or ordinary skill in the art (“POSITA”) after reviewing the detailed description which follows.

### BRIEF DESCRIPTION OF THE DRAWING FIGURES

FIG. 1, identified as “prior art,” presents an illustrative example of trotline crabbing.

FIG. 2, identified as “prior art,” shows a conventional trotline crabber netting a crab.

FIGS. 3 and 4, identified as prior art, are “snapshots” depicting the conventional trotline crabber re-loading a conventional bait bag following conventional process steps.

FIG. 5, identified as prior art, is a “snapshot” presenting a knot formed in a trotline.

FIG. 6, also “prior art,” depicts a side elevational view of a conventional bait bag.

FIG. 7 presents a side elevational view of a bait bag of the present subject matter.

FIGS. 8 and 9, each a “bird's-eye-view,” show a person using a mechanism of the present subject matter for re-loading a plurality of bait bags of the present subject matter.

FIG. 10 is a front elevational view of the mechanism of the present subject matter.

FIGS. 11, 12 are front and back elevational views, respectively, of the mechanism.

FIG. 13 is an elevational view of the mechanism shown in FIG. 10, from the right.

FIG. 14 depicts a motor-providing component for a mechanism shown in FIG. 10.

FIG. 15 presents one feature of a component of the mechanism depicted in FIG. 14.

FIG. 16 shows an alternative view of an on/off control mechanism configured to be operatively connected to the mechanism of the present subject matter depicted in FIG. 10.

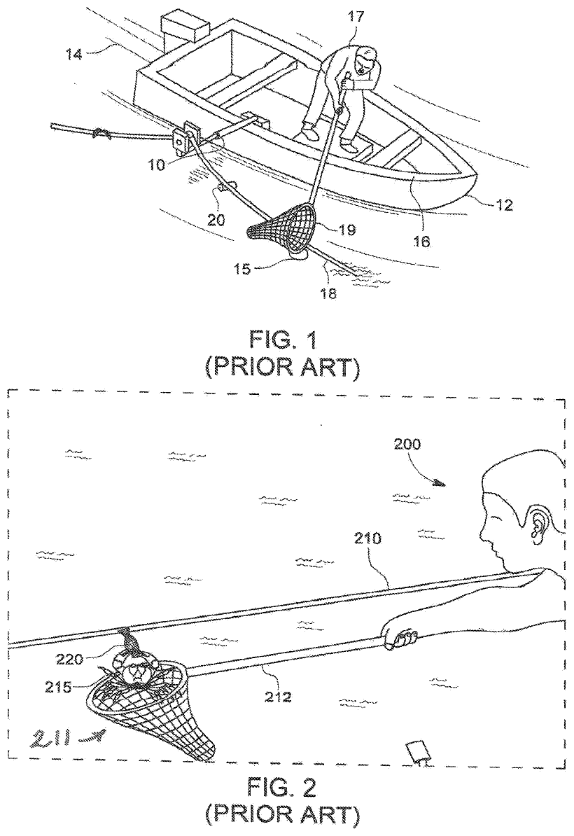

Throughout the drawing figures and detailed description (which follows), I shall use similar reference numerals to refer to similar components of the present subject matter.

### DETAILED DESCRIPTION

Before describing the present subject matter-my invention-in detail, I want to provide a few visual images regarding current trotline-crabbing practice, for enabling a person of ordinary skill in the art (“POSITA”) reading this patent specification to better understand why my bag design and mechanism for re-baiting trotlines will be viewed by many commercial trotline crabbers as much-needed, time-saving articles of manufacture.

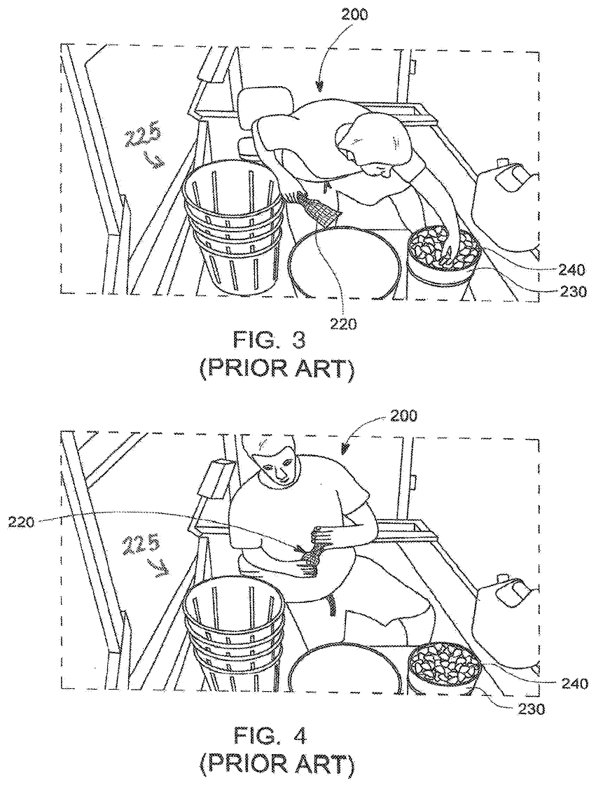

In FIG. 2, a trotline crabber 200 uses a conventional trotline 210 and conventional bag 220 attached to the trotline 210 to catch a crab 215 lured to bag 220. Crabber 200 uses a net 211 attached to a handle 212 to catch the crab 215 (shown attached to the bag 220). FIG. 3 shows a trotline crabber 200 reaching into a bucket 230 to grasp with his/her left palm a handful of (e.g., 3-6) clams 240 which are to be transferred into a conventional bag 200 held in his/her right palm while seated on a conventional trotline-crabbing boat 225. FIG. 4 presents the trotline crabber 200 after the clams have been inserted into the bag 220.

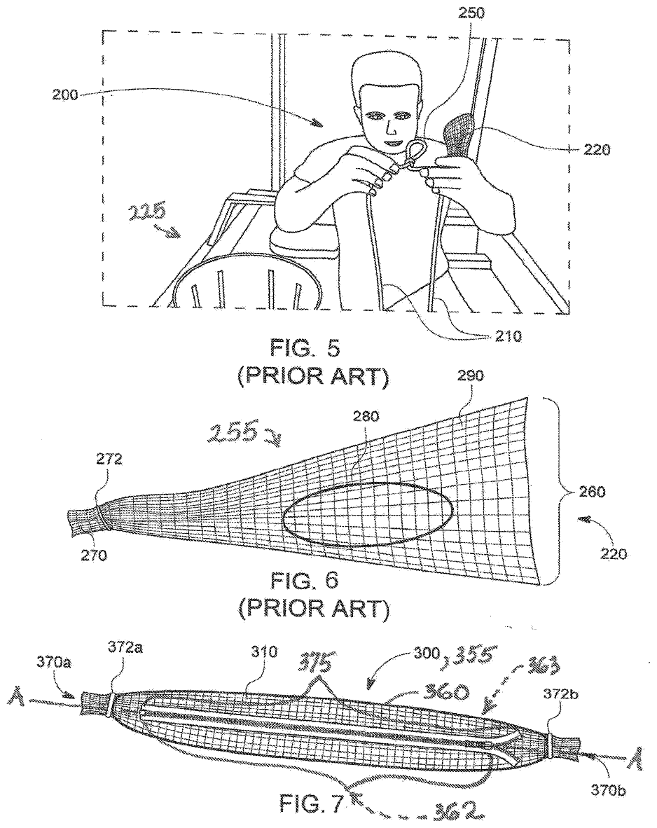

FIG. 5 depicts the trotline crabber 200 displaying a special knot 250 formed in the trotline 210 for removably securing a conventional bag 220 to a trotline 210. FIG. 6 depicts a conventional bag 220 consisting of an elongated body 255 having opposite end portions. The body 255 includes a sidewall 290 having a primary opening 260 at one end portion thereof and has an opposite end portion (at end 270) closed by a clasp 272. The sidewall 290 includes a plurality of secondary openings 280 (many of which are shown encircled). Secondary openings 280 are defined by a mesh barrier structure. (The term “mesh” as used throughout this patent specification shall be understood to mean a barrier manufactured of connected strands, collectively made of fiber or from other flexible or ductile materials.) The entire sidewall 290 of a conventional bag 220 is essentially a mesh barrier structure. In operation, a trotline crabber 200 produces a knot 250 according to a known procedure for securely closing the opening 260 -after a bag 200 has been re-loaded with “fresh” crab bait- for securing the bag 220 to the trotline 210. The knot 250 allows a trotline crabber 200 to easily remove a bag 220 containing “spent” bait from the trotline 210 when desired.

FIG. 7 presents an embodiment of a trotline-crabbing bag 300 of the present subject matter. The bag 300 has an elongated body 355, shaped as a sleeve, with opposite end portions 370a and 370b, each of which is closed by an associated clasp 372a and 372b. The body 355 includes a sidewall 360 defining a primary opening 362 longitudinally oriented along an axis A-A and dimensioned for introducing crab bait (e.g., 3-6 clams) into the body 355. (The primary opening 362 is hidden behind a slide fastener 375.) The body 355 defines an interior region 363 for receiving crab bait introduced through the primary opening 362 and into the body 355. The interior region 363 is bounded by sidewall 360. Sidewall 360 is configured to define a plurality of secondary openings 310 which are defined by a mesh barrier structure. Secondary openings 310 each range from about 3 millimeters (“mm”) to about 8 mm for attracting at least one crab to sidewall 360, to feed on crab bait in bag 300. The sidewall 360 is designed, adapted, and configured to achieve at least two objectives. One of the objectives being served by the shape (e.g., circular, elliptical, triangular, square-shaped, rectangular-shaped, pentagonal-shaped, hexagonal-shaped, heptagonal-shaped, octagonal shaped) of the secondary openings 310 and the distance between spaced-apart edge margins of proximate secondary openings 310 for enabling one or more target crabs to securely attach themselves to the sidewall 360 to feed upon the fresh crab bait therein.

The body 355 includes a slidably openable and closeable slide fastener 375 (overlaying the primary opening 362) and fixed (e.g., stitched) to the sidewall 360 between the opposite end portions 370a, 370b. (Primary opening 362 is hidden by slide fastener 375.) The slide fastener 375, when open, enables crab bait to be inserted into the interior region 363 and, when closed, securely retains the crab bait within the interior region 363.

In embodiments, sidewall 360 can be manufactured from a variety of fiber-based materials or from assorted flexible or ductile materials which include but are not limited to a material that is selected from the group consisting of aramid fiber, cotton, high-density polyethylene (“HDPE”), nylon (e.g., “nylon 6,6”), polyethylene, polyurethane, and rayon.

In embodiments, a bag 300 can have a generally cylindrical body 355 and can be shaped as an elongated sleeve of nylon mesh and having secondary openings 310 that range from about 1 millimeter (“mm”) to about 10 mm (or about 3 mm to about 8 mm or about 4 mm to about 7 mm). In embodiments, the slide fastener 375 may be a conventional zipper. In embodiments, the bag 300 could be releasably secured to a trotline 210 by a releasable knot, such as the knot 250, skillfully formed at spaced-apart intervals along a trotline 210.

The slide fastener 375 is fixed to the sidewall 360 to overlay the primary opening 362 for enabling a person (e.g., a trotline crabber) to open a bag 300 to remove “spent” bait and, thereafter, re-load the bag 300 with “fresh” bait. Later, when fresh bait eventually becomes “spent,” meaning that such bait is no longer able to attract a crab to the bag 300 (secured to trotline 210), the slide fastener 375 enables a person to open the bag 300 for discarding the “spent” bait and, thereafter, again “re-loading” the bag 300 with “fresh” bait.

Utility of the present invention will become clear after reading how my bag design significantly reduces amount-of-time a trotline crabber must devote to re-baiting a trotline.

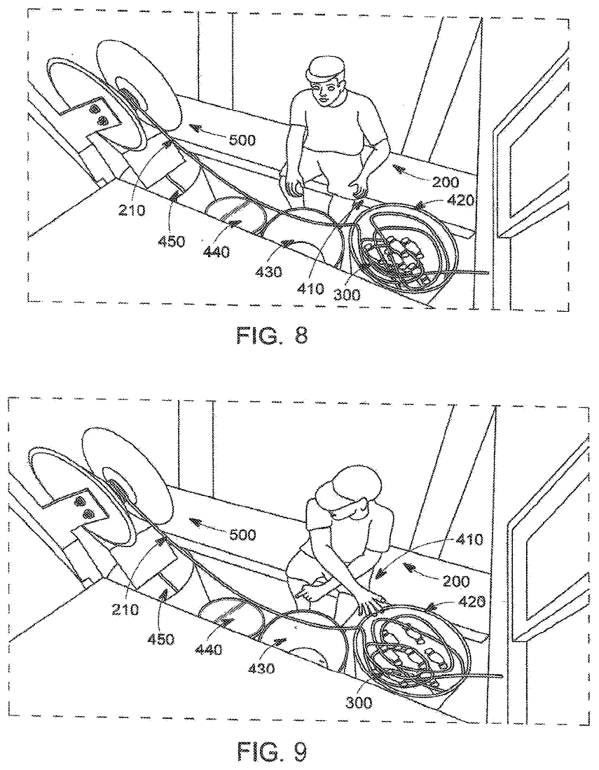

FIGS. 8 and 9 exemplify a time-saving feature of the present subject matter. For example, instead of a trotline crabber needing to remove a plurality of conventional bags 220 from a trotline 210, to replace “spent” crab bait with “fresh” bait, a trotline crabber 200 now only needs to use slide fastener 375 on each bag 300 (of present subject matter), to reload each such bag 300 with “fresh” bait without ever removing a single bag 300 from a trotline 210. Instead of interrupting a crabber 200 (ordinarily trotline crabbing on a boat) for purposes of “re-loading” bags (containing “spent” crab bait) with “fresh” bait, as shown in FIG. 5, the trotline baiting mechanism 500 of the present subject matter is portable and, therefore, can be located anywhere, such as an “off-boat” location shown in FIGS. 8, 9.

Furthermore, the mechanism 500 of the present invention, which is portable, can be located on a boat or anywhere else. For instance, there is shown in FIGS. 8, 9 an elongated horizontal surface or bench 410 on which a person, for instance, a trotline crabber 200 can sit. Adjacent to a horizontal surface or bench 410 is a first bucket 420 containing a plurality of bags 300 of the present subject matter, with each bag removably secured to trotline 210.

In accordance with the present subject matter, only a bag 300 that has become damaged while in “crabbing” use will need to be removed from a trotline 210 and replaced.

When seated, trotline crabber 200 can reach into a first bucket 420 with one hand as shown in FIG. 9 to fetch a trotline-crabbing bag 300 secured to the trotline 210, then zip-open a fetched bag 300, toss “spent” bait into a second bucket or container 430, fetch from a third bucket or container 440 “fresh” bait, add the fresh bait into a zipped-open bag 300, zip-close a fresh-bait filled bag 300, and use a pedal apparatus 611 (FIG. 6) associated with the reel mechanism 500, for the purpose of advancing a plurality of fresh-bait filled bags 300 secured to the trotline 210, into a fourth bucket or receptacle 450 (FIGS. 9, 11).

Thereafter, a plurality of bags 300 (please see FIGS. 8 and 9) are removably secured to the trotline 210 at space intervals (along trotline 210) that are spaced (preferably equally) from the two nearest bags 300 (of the plurality of bags 300) which are on the trotline 210.

Furthermore, while each bag 300 (FIG. 7) can be removably secured to the trotline 210 via a knot 250 (as shown in FIG. 5), a person of ordinary skill in the art (“POSITA”) may know about retainers such as an assortment of snap hooks disclosed in U.S. Pat. No. 4,464,813 to Bakker et al. (hereby incorporated by reference in its entirety) for removably securing bags 300 to a trotline 210, if removal of bags 300 from trotline 210 is necessary.

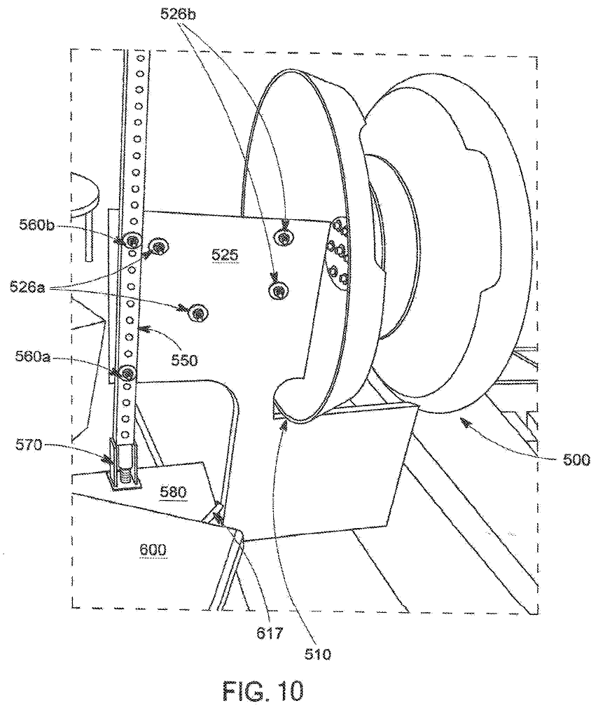

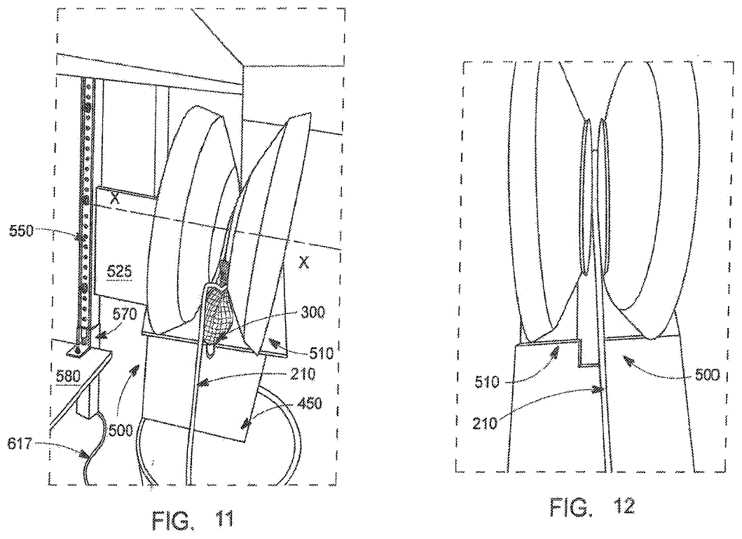

Please refer to FIGS. 10, 11, 12, 13, 14 ,15 for a detailed description of a prototype of a trotline baiting mechanism 500 designed to be used with a predetermined length of trotline 210 to which the plural bags 300 are removably secured at spaced-apart intervals.

The mechanism 500 includes a conventional reel 510 rotatable about an axis X-X (FIG. 11) for transferring bags 300 (secured to a trotline 210 at spaced-apart regions) from a first region, e.g., first bucket 420 (FIGS. 8,9), to a second region, e.g., fourth bucket 450.

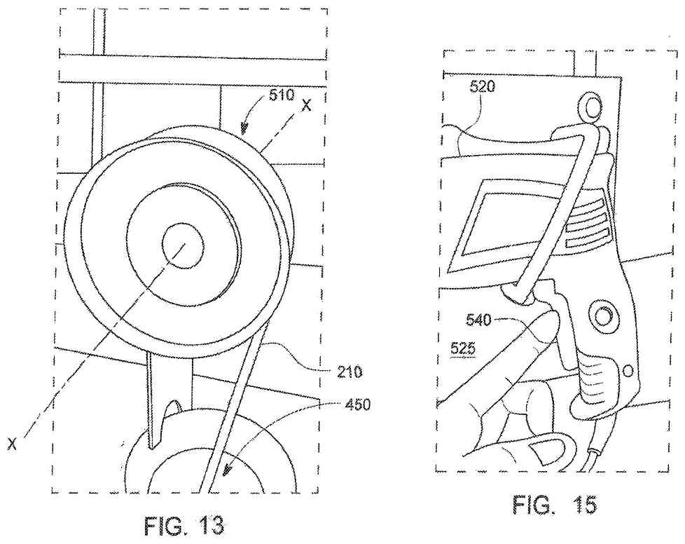

A reel mechanism 500 of the present subject matter includes a conventional motor for powering rotation of the reel 510 about the axis X-X (FIG. 13). One such motor can, for example, be a motor of a conventional hand-held drill 520 (FIG. 14). The drill 520 is secured by a pair of brackets 527, 529 to a surface of a planar support structure 525 by suitably sized threaded-fastener components 526a and 526b (FIG. 10). The brackets 527, 529 themselves are sized and arranged about the hand-held drill 520 for securely retaining the drill 520 while also allowing unrestrained rotation of the reel 510 about the axis X-X.

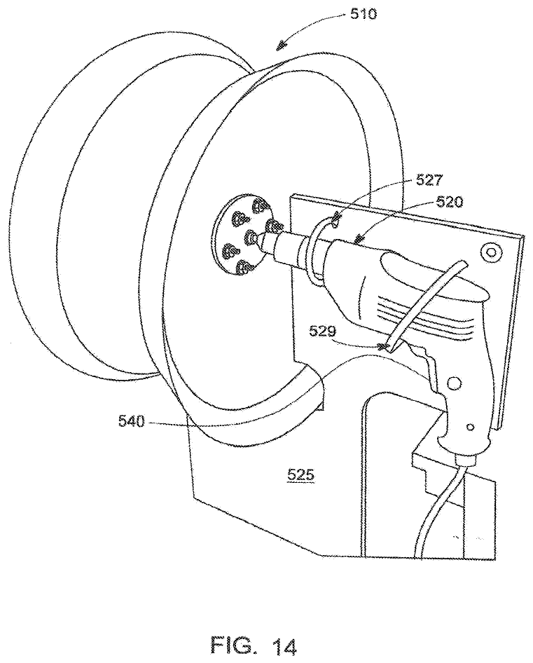

The drill 520, a component of reel mechanism 500, has a trigger 540 (FIG. 15) for adjusting and therefore “setting” a preferred rotational speed for reel 510 about axis X-X.

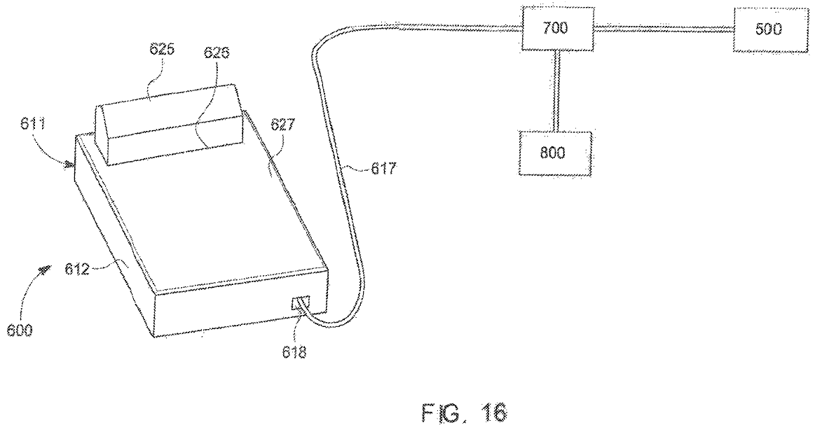

Additionally, a conventional on/off control mechanism 600 (FIG. 16) is operatively connected to the reel mechanism 500 (FIG. 10) by a common power cable 617 and a control system 700. The on/off control mechanism 600, in turn, includes a foot-pedal apparatus 611 comprising a partially hollow base 612, and a spring-biased foot pedal 625 partially depressible along an edge margin 626 into the base 612 for starting and/or stopping rotation of the reel 510 about the axis X-X (FIG. 11) , further including a relatively flat upper surface 627 for a trotline crabber 200 to rest his/her foot when engaging the foot pedal 625. In operation, depression of the foot pedal 625 into the base 612 starts rotation of reel 510 about axis X-X and repeating depression of the foot pedal 625 into base 612 stops rotation of the reel 510 about the axis X-X. A power system 800 provides power to the control system 700, which operatively connects reel mechanism 500 to the on/off mechanism 600. Power cable 617 extends from control system 700 into cable inlet 618 formed in base 612.

The reel mechanism 500 of the illustrated embodiment of the present subject matter includes a vertically oriented mounting bar 550 (FIG. 10) to which the planar support structure 525 is held firmly in place by a pair of conventional threaded-fastener components 560a and 560b. In addition, the mounting bar 550 is securely held in place by a clamp 570 secured to a worktable 580 by the jaws (of a clamp 570) fixed to the underside of table 580.

Accordingly, operation of the reel mechanism 500 of the present subject matter thus enables a person sitting on a bench 410 (as shown in FIGS. 8 and 9) to reach into a first bucket 420 to fetch a bag 300 containing spent crab bait on a trotline 210 and thereafter use a slide fastener 375 (as shown in FIG. 7) to open the bag 300, remove the spent bait, re-load the bag 300 with fresh bait, and use its slide fastener 375 to close a fresh bait-loaded bag 300, and then transfer fresh bait-loaded bags 300 to another bucket 450 (see, e.g., FIGS. 9, 11) and finally use an on/off control mechanism 600 (shown in FIG. 16) until another bag 300 on trotline 210 is close enough for the person to repeat the process steps described.

A person of ordinary skill in the art (“POSITA”) is aware that the control system 700, the disclosed components of reel mechanism 500, and the disclosed components of on/off control mechanism 600 are all modifiable for enabling the embodiments of the reel mechanism 500 and/or the control mechanism 600 disclosed herein to be fully portable.

Accordingly, when the reel mechanism 500 is operated by a person such as a trotline crabber a manner to achieve process steps described above, the reel mechanism 500 could very easily be used by a person of ordinary skill in the art (“POSITA”) of trotline crabbing, for substituting fresh bait for the spent bait present in a plurality of bags 300, located at spaced-apart intervals along a length of a trotline 210, faster than can be done at the present time. Moreover, since the reel mechanism 500 is not required to be on a trotline crabbing vessel, a trotline crabber (currently on such a vessel) is free to engage in trotline crabbing.

Illustrated and described throughout this patent specification is trotline crabbing bag and a mechanism developed to reduce amount of time required by trotline crabbers to replace “spent” bait with “fresh” bait in a plurality of trotline-crabbing bags on a common trotline. The present disclosure describes a trotline-crabbing bag that trotline crabbers will find useful. While the present subject matter is described in connection with exemplary embodiments, the present subject matter is not limited to the embodiments disclosed. On the contrary, numerous alternatives, changes, and/or modifications will become apparent to a person of ordinary skill in the prior art (“POSITA”) after this patent specification has been reviewed in connection with associated drawing figures. Therefore, all such alternatives, changes, and/or modifications are to be understood as forming a part of the present disclosure insofar as they fall within the spirit and scope of the appended claims.

1. A trotline-crabbing bag releasably securable to a trotline, wherein the trotline-crabbing bag comprises:
an elongated body defining a sidewall having an external surface, wherein the elongated body is sleeve-shaped and defines opposite end portions, wherein each of the opposite end portions of the elongated body is closed, wherein the elongated body defines an interior region bounded by the sidewall, wherein the elongated body is dimensioned and configured for enabling a predetermined amount of crab bait comprising 3-6 clams to be disposed within the interior region of the elongated body for attracting one or more crabs to the external surface of the sidewall of the elongated body,
wherein the sidewall defines:
a primary opening configured and dimensioned for inserting the crab bait comprising the 3-6 clams into the interior region of the elongated body, wherein the primary opening of the sidewall is located between the opposite end portions of the elongated body, and
a plurality of secondary openings dimensioned to release a scent of the bait contained within for attracting the one or more crabs to the sidewall, whereupon the one or more attracted crabs attach themselves to the external surface of the sidewall to feed on the crab bait comprising the 3-6 clams in the interior region of the elongated body, and
a slidably openable and closeable slide fastener operatively overlaying the primary opening and secured to the sidewall between the opposite end portions of the elongated body, wherein the slide fastener when open enables the crab bait comprising the 3-6 clams to be inserted into the interior region of the elongated body, and wherein the slide fastener when closed retains the crab bait comprising the 3-6 clams in the interior region of the elongated body.

2. The trotline-crabbing bag of claim 1, wherein the sidewall is made of a material selected from the group consisting of aramid fiber, cotton, high density polyethylene (HDPE), nylon, polyethylene, polyurethane, and rayon.

3. The trotline-crabbing bag of claim 1, wherein the trotline-crabbing bag is manufactured from a nylon mesh bag.

4. The trotline-crabbing bag of claim 3, wherein the secondary openings range from about 1 mm to about 10 mm.

5. The trotline-crabbing bag of claim 4, wherein the slide fastener is a zipper, and wherein the trotline-crabbing bag is releasably secured to a trotline by a releasable knot formed in the trotline.

6. A trotline-baiting mechanism for use with a predetermined length of trotline having a plurality of bags secured thereto at spaced-apart intervals along the length, comprising:
a reel rotatable about an axis for causing portions of the trotline and the plurality of trotline-secured bags to be transferred from a first location to a second location;
a motor for powering rotation of the reel about the axis; and
an on/off mechanism configured for providing a user with on/off control of the motor.

7. The trotline-baiting mechanism of claim 6, wherein the on/off mechanism is configured for enabling a user to engage a pedal adapted for causing the motor to power off and on.

8. The trotline-baiting mechanism of claim 6, wherein a motor of a hand-held drill is used to power rotation of the reel about the axis, wherein the mechanism includes a stand for rotatably mounting the reel for rotation about the axis, wherein the stand includes a surface portion, and wherein the drill is removably secured to the surface portion.

9. The trotline-baiting mechanism of claim 8, wherein the hand-held drill includes a trigger mechanism for controlling rotational speed of the reel about the axis.

10. The trotline baiting mechanism of claim 6, wherein at least one bag of the plurality of bags comprises:
an elongated body having opposite end portions and a sidewall, wherein the body defines an interior region bounded by the sidewall, wherein the sidewall defines:
a primary opening dimensioned for inserting crab bait into the body, wherein the primary opening is located between the opposed end portions, and
a plurality of secondary openings dimensioned for attracting at least one crab to the interior region for purposes of feeding on the crab bait in the bag, and
a slidably openable and closeable slide fastener overlaying the primary opening and secured to the sidewall between the opposite end portions, wherein the slide fastener when open enables crab bait to be inserted into the interior region, and wherein the slide fastener when closed retains the crab bait in the interior region.

11. The trotline baiting mechanism of claim 10, wherein the sidewall is made of a material selected from the group consisting of aramid fiber, cotton, HDPE, nylon, polyethylene, polyurethane, and rayon.

12. The trotline baiting mechanism of claim 10, wherein the at least one bag is a nylon mesh bag.

13. The trotline baiting mechanism of claim 12, wherein the secondary openings range from about 1 mm to about 10 mm.

14. The trotline baiting mechanism of claim 13, wherein the slide fastener is a zipper, and wherein the at least one bag is removably secured to the trotline by a preselected, removable knot formed in the trotline.

15. The trotline-crabbing bag of claim 1, wherein the slide fastener is a zipper.

16. The trotline-crabbing bag of claim 1, wherein one of the end portions of the elongated body is releasably secured to a trotline by a releasable knot formed in the trotline.

17. The trotline-crabbing bag of claim 1, wherein each of the opposite end portions of the elongated body is closed by a respective clasp.
